(19) United States
(12) Patent Application Publication
(10) Pub. No.: US 2013/0216190 A1
(43) Pub. Date: Aug. 22, 2013

(54) OPTICAL ASSEMBLY WITH FERRULE AND FRAME

(71) Applicants: Edmund J. Haley, Dillsburg, PA (US); David Robert Baechtle, Dillsburg, PA (US)

(72) Inventors: Edmund J. Haley, Dillsburg, PA (US); David Robert Baechtle, Dillsburg, PA (US)

(73) Assignee: TYCO ELECTRONICS CORPORATION, Berwyn, PA (US)

(21) Appl. No.: 13/400,449

(22) Filed: Feb. 20, 2012

(51) Int. Cl. G02B 6/36

(52) U.S. Cl. 385/79; 385/78

(57) ABSTRACT

An optical cable assembly is provided for being connected to an opto-electric device assembly having a substrate, an opto-electric device (OED) mounted on the substrate, and a frame mounted on the substrate. The optical cable assembly includes an optical cable including an optical conductor having an end. A ferrule terminates the optical cable. The ferrule includes a body having a chamber. The optical conductor is held by the ferrule such that at least a portion of the end of the optical conductor extends within the chamber of the body of the ferrule. The body of the ferrule is configured to be engaged with and removably connected to the frame of the electro-optical device assembly to optically connect the optical conductor to the OED.

### BACKGROUND OF THE INVENTION

The subject matter described and/or illustrated herein relates generally to optical cables and opto-electric devices.

Optical cables are used in a wide variety of applications for transmitting optical signals over a distance. Some optical cables interface with opto-electric devices (OEDs) of a larger host system for converting optical signals carried by the cable between the optical medium and an electrical medium. OEDs are often installed in larger host systems such as, routers, computers, and/or the like and are typically mounted on a substrate (e.g., a printed circuit), which may include circuitry and/or other components that facilitate operation of the OEDs. As competition and market demands have continued the trend toward smaller and higher performance (e.g., faster) electronic systems, the available space for optically connecting optical cables to OEDs within the host system may be limited.

Some known optical cables are optically connected to OEDs by directly attaching the optical conductors of the optical cables to the OEDs. However, connectors have been developed to enable optical cables to be disconnected from OEDs without damaging or destroying the cable and/or the OEDs. Such connectors typically include a connector half that is optically connected to a ferrule of an optical cable and another connector half that is optically connected to one or more OEDs. The connector halves mate together to enable the optical cable to be removably connected to the OED(s). But, such connectors may be larger and therefore take up more space than is available within the host system.

### BRIEF DESCRIPTION OF THE INVENTION

In one embodiment, an optical cable assembly is provided for being connected to an opto-electric device assembly having a substrate, an opto-electric device (OED) mounted on the substrate, and a frame mounted on the substrate. The optical cable assembly includes an optical cable including an optical conductor having an end. A ferrule terminates the optical cable. The ferrule includes a body having a chamber. The optical conductor is held by the ferrule such that at least a portion of the end of the optical conductor extends within the chamber of the body of the ferrule. The body of the ferrule is configured to be engaged with and removably connected to the frame of the electro-optical device assembly to optically connect the optical conductor to the opto-electric device (OED).

In another embodiment, an optical assembly includes an opto-electric device assembly having a substrate, an opto-electric device (OED) mounted on the substrate, and a frame mounted on the substrate. The OED is configured to at least one of convert optical signals to electrical signals or convert electrical signals to optical signals. The optical assembly also includes an optical cable having an optical conductor that includes an end. A ferrule terminates the optical cable. The ferrule includes a body having a chamber. The optical conductor is held by the ferrule such that at least a portion of the end of the optical conductor extends within the chamber of the body of the ferrule. The body of the ferrule is engaged with and removably connected to the frame of the opto-electric device assembly to optically connect the optical conductor to the OED.

In another embodiment, an optical cable assembly is provided for being connected to an opto-electric device assembly having an opto-electric device (OED) and a substrate. The assembly includes an optical cable including an optical conductor having an end. A frame is configured to be mounted on the substrate of the opto-electric device assembly. A ferrule terminates the optical cable. The ferrule includes a body having a chamber. The optical conductor is held by the ferrule such that at least a portion of the end of the optical conductor extends within the chamber of the body of the ferrule. The body of the ferrule is engaged with and removably connected to the frame to optically connect the optical conductor to the OED.

### BRIEF DESCRIPTION OF THE DRAWINGS

FIG. 1 is a perspective view of an exemplary embodiment of an optical assembly.

FIG. 2 is a perspective view of an exemplary embodiment of an optical cable and a portion of a ferrule that terminates the optical cable of the optical assembly shown in FIG. 1.

FIG. 3 is a perspective view of an exemplary embodiment of a connection member of the optical assembly shown in FIG. 1.

FIG. 4 is a partially exploded perspective view of an exemplary embodiment of an opto-electric device (OED) assembly of the optical assembly shown in FIG. 1.

FIG. 5 is an exploded perspective view of a portion of an exemplary alternative embodiment of an optical assembly.

FIG. 6 is an exploded perspective view of a portion of another exemplary alternative embodiment of an optical assembly.

FIG. 7 is a partially exploded perspective view of a portion of another exemplary alternative embodiment of an optical assembly.

FIG. 8 is a partially exploded perspective view of a portion of yet another exemplary alternative embodiment of an optical assembly.

FIG. 9 is a partially exploded perspective view of a portion of still another exemplary alternative embodiment of an optical assembly.

FIG. 10 is a broken-away perspective view of a portion of another exemplary alternative embodiment of an optical assembly.

FIG. 11 is a partially exploded perspective view of a portion of yet another exemplary alternative embodiment of an optical assembly.

### DETAILED DESCRIPTION OF THE INVENTION

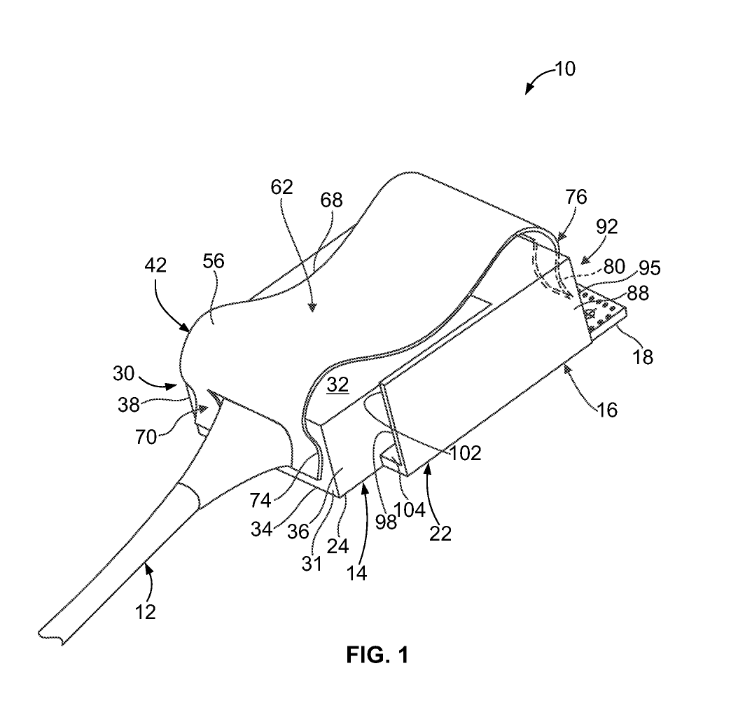

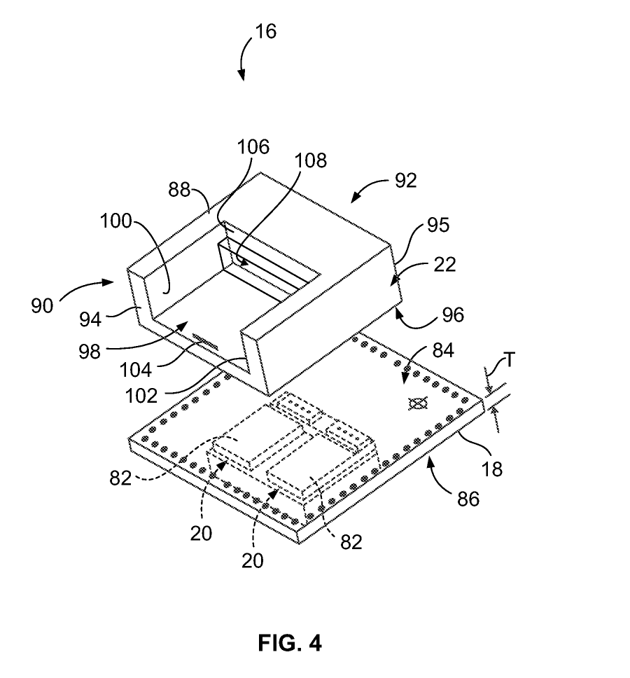

FIG. 1 is a perspective view of an exemplary embodiment of an optical assembly 10. The optical assembly 10 includes an optical cable 12, a ferrule 14 terminating the optical cable 12, and an opto-electric device (OED) assembly 16. The OED assembly 16 includes a substrate 18, one or more opto-electric devices (OED) 20 (FIG. 4), and a frame 22. Generally, the OEDs 20 convert optical signals received from the optical cable 12 into electrical signals, and/or convert electrical signals into optical signals for reception by the optical cable 12. As will be described in more detail below, the ferrule 14 is configured to be engaged with and removably connected to the frame 22 of the OED assembly 16 to optically connect the optical cable 12 to the OEDs 20. A combination of the optical cable 12 and the ferrule 14 may be referred to herein as an “optical cable assembly”. Additionally, a combination of the optical cable 12, the ferrule 14, and the frame 22 may be referred to herein as an “optical cable assembly”.

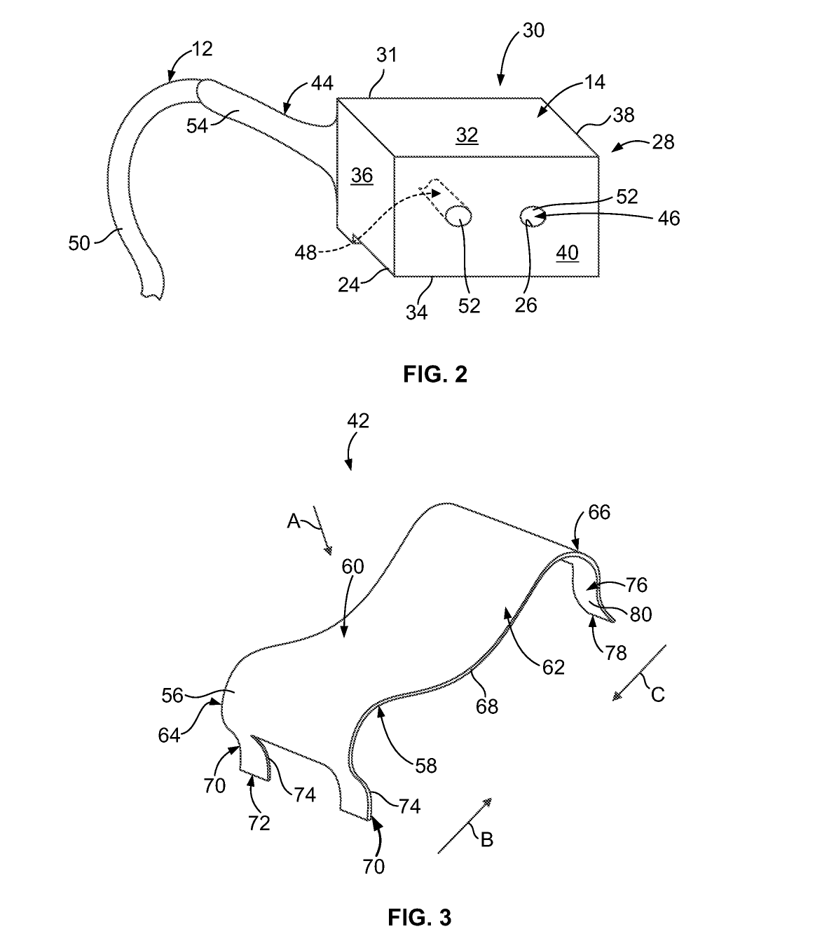

FIG. 2 is a perspective view of the optical cable 12 and a portion of the ferrule 14. The ferrule 14 includes a body 24 having one or more chambers 26. In the exemplary embodiment, the chamber 26 is an internal chamber of the body 24. But, the chamber 26 may alternatively be an external chamber (e.g., a groove, recess, depression, and/or the like that extends into an external surface of the body 24. The body 24 of the ferrule 14 extends a length from a front end 28 to a rear end 30. The rear end 30 includes a rear face 31. In the exemplary embodiment, opposite side walls 32 and 34 of the body 24 extend from the front end 28 to the rear end 30. The body 24 also includes opposite side walls 36 and 38 that extend from the front end 28 to the rear end 30 and intersect the side walls 32 and 34. The front end 28 includes a front face 40. In some alternative embodiments, the ferrule 14 includes a lens (not shown), a reflector (not shown), and/or the like.

In the exemplary embodiment, the ferrule 14 also includes a connection member 42 (FIGS. 1 and 3), which is not shown in FIG. 2. As will be described in more detail below, the connection member 42 is used to removably connect the ferrule body 24 to the frame 22 (FIGS. 1 and 4) of the OED assembly 16 (FIGS. 1 and 4). The connection member 42 will be described in more detail below with reference to FIG. 3. Although shown as having the general shape of a parallelepiped, the body 24 of the ferrule 14 may additionally or alternatively include any other shape.

The optical cable 12 extends a length from an end 44 to an opposite end (not shown). The cable 12 includes one or more optical conductors 46 that extend along the length of the cable 12. The optical conductors 46 are configured to transmit optical signals therealong. The optical conductors 46 include ends 48. Optionally, the optical cable 12 includes a cable jacket 50 that surrounds the optical conductors 46 along at least a portion of the length of the cable 12. The end 44 of the optical cable 12 is terminated by the ferrule 14. More specifically, the ferrule 14 holds the end 44 of the optical cable 12 such that the ends 48 of the optical conductors 46 extend within the chambers 26 of the ferrule body 24. In the exemplary embodiment, the body 24 of the ferrule 14 holds the ends 48 of the optical conductors 46 in a spaced relationship to each other. As can be seen in FIG. 2, end surfaces 52 of the optical conductor ends 48 are exposed at the front face 40 of the body 24 of the ferrule 14 for optical connection of the optical conductors 46 to the OEDs 20 (FIGS. 1 and 4). In the exemplary embodiment, the end surfaces 52 of the optical conductor ends 48 are flush with the front face 40 of the ferrule body 24. Alternatively, the end surfaces 52 are not flush with the front face 40 such that the optical conductor ends 48 extend only partially through the ferrule body 24 and end surfaces 52 are spaced inwardly (relative to the ferrule body 24) from the front face 40. In such alternative embodiments wherein the end surfaces 52 are not flush with the front face 40, the ends surfaces 52 may be exposed through an opening extending through the front face 40, may be exposed through a lens of the ferrule 14, and/or may be exposed via a reflector of the ferrule 14. Optionally, the front face 40 of the ferrule body 24 and/or the end surfaces 52 of the optical conductor ends 48 are polished to facilitate optical connection of the optical conductors 46 to the OEDs 20.

The optical cable 12 includes an optional cable boot 54 that extends over a portion of the end 44 of the optical cable, for example, for protecting, sealing, and/or the like the interface between the optical cable 12 and the ferrule 14 proximate the rear end 30 of the ferrule 14, for providing strain relief to the cable 12, and/or the like.

FIG. 3 is a perspective view of an exemplary embodiment of the connection member 42. The connection member 42 includes a body 56 having an inner side 58 and an opposite outer side 60. The body 56 of the connection member 42 includes a base 62 that extends from an end 64 to an opposite end 66. The base 62 includes an optional engagement segment 68 that is offset (e.g., curved and/or the like) inwardly in the direction of the arrow A. As will be described below, the engagement segment 68 is optionally configured to engage the ferrule 14 (FIGS. 1 and 2) on the inner side 58.

The body 56 of the connection member 42 includes one or more ferrule arms 70 that extend from the end 64 of the base 62. Specifically, each ferrule arm 70 extends from the end 64 of the base 62 to a free end 72. Each ferrule arm 70 is configured to engage the ferrule 14, as will be described in more detail below. The ferrule arms 70 include optional engagement segments 74 that are offset (e.g., curved and/or the like) inwardly in the direction of the arrow B. One or more frame arms 76 extend from the end 66 of the base 62. The frame arms 76 extend from the end 66 of the base 62 to free ends 78. The frame arms 76 are configured to engage the frame 22 (FIGS. 1 and 4). Optionally, each frame arm 76 includes an engagement segment 80 that is offset (e.g., curved and/or the like) inwardly in the direction of the arrow C. Although two are shown, the body 56 of the connection member 42 may include any number of the ferrule arms 70. Similarly, the body 56 may include any number of the frame arms 76.

In the exemplary embodiment, the connection member 42 is a spring clip. More specifically, at least a portion of the body 56 of the connection member 42 is a spring. The body 56 is shown in FIG. 3 in a natural resting position. The body 56 is configured to be deflected, against the bias to the natural resting position, along the base 62, the ferrule arms 70, and/or the frame arms 76.

FIG. 4 is a partially exploded perspective view of an exemplary embodiment of the (OED) assembly 16. As described above, the OED assembly 16 includes the substrate 18, one or more of the OEDs 20, and the frame 22. In the exemplary embodiment, the OED assembly 16 includes two OEDs 20. The OEDs 20 are each selected as being configured to convert optical signals into electrical signals (a receiver), being configured to convert electrical signals into optical signals (a transmitter), and/or being configured to both convert electrical signals into optical signals and convert optical signals into electrical signals (a transceiver). Each OED 20 includes an active area 82 that emits optical signals and/or is sensitive to the impingement of an optical signal thereon.

The substrate 18 has a thickness T defined between a pair of opposite sides 84 and 86. The OEDs 20 and the frame 22 are mounted on the substrate 18. In the exemplary embodiment, the OEDs 20 are mounted on the side 86 of the substrate 18 and the substrate 18 is at least partially transparent such that the active areas 82 of the OEDs 20 are optically accessible from the side 84 on which the frame 22 is mounted. In other words, the active areas 82 of the OEDs 20 can receive optical signals that are transmitted through the thickness T of the substrate 18 from the substrate side 84, and optical signals emitted by the OEDs 20 on the side 86 of the substrate 18 are transmitted through the substrate thickness T and can be received on the substrate side 84. Alternatively, one or more of the OEDs 20 are mounted on the side 84 of the substrate 18 for emitting and/or receiving optical signals on the side 84 in an arrangement wherein the optical signals are not transmitted through the substrate thickness T. The substrate 18 optionally includes one or more active and/or passive circuits (not shown), one or more active and/or passive components (not shown), and/or the like that facilitate operation of the OEDs 20, for example to electrically connect the OEDs 20 to a generator and/or receiver of electrical signals. Optionally, the substrate 18 is a printed circuit.

The frame 22 includes a body 88 that extends a length between a front end 90 and a rear end 92. The front end 90 includes a front face 94, and the rear end 92 includes a rear face 95. The body 88 of the frame 22 is mounted on the side 84 of the substrate 18 along a bottom side 96 of the frame body 88. The body 88 includes a receptacle 98, which in the exemplary embodiment extends through the front face 94 of the frame body 88. The receptacle 98 is defined by opposing side walls 100 and 102, a bottom wall 104, and a rear wall 106. In the exemplary embodiment, the frame 22 includes a lens 108 mounted on the rear wall 106. The lens 108 is configured to bend optical signals approximately 90° in the exemplary embodiment, but the lens 108 may bend optical signals at any other angle. As described below, the lens 108 is configured to direct optical signals between the active areas 82 of the OEDs 20 and the ends 48 (FIG. 2) of the optical conductors 46 (FIG. 2). In the exemplary embodiment, the frame body 88 includes an opening (not shown) that exposes the lens 108 through the bottom side 96 of the body 88 to enable optical signals to be transmitted between the lens 108 and the OEDs 20. Alternatively, the frame body 88 is at least partially transparent such that optical signals can be transmitted through the body 88 between the lens 108 and the OEDs 20. In addition or alternative to the lens 108, the frame 22 may include a reflector (not shown) for directing optical signals between the OEDs 20 and the optical conductors 46.

Referring again to FIG. 1, the ferrule 14 is engaged with and removably connected to the frame 22 such that the optical cable 12 is optically connected to the OEDs 20. Specifically, the body 24 of the ferrule 14 is received within the receptacle 98 of the frame body 88. At least some portion of the ferrule body 24 engages the frame body 88 when received within the receptacle 98. For example, the side wall 36 of the ferrule body 24 may engage the side wall 102 of the frame body 88, the side wall 38 (FIG. 2) may engage the side wall 100 (FIG. 4), the side wall 34 may engage the bottom wall 104, and/or the like. Optionally, the front face 40 (FIG. 2) of the ferrule body 24 may engage the lens 108 (FIG. 4) of the frame 22 when the ferrule body 24 is received within the receptacle 98 of the frame body 88.

The body 56 of the connection member 42 engages the body 88 of the frame 22 to removably connect the ferrule 14 to the frame 22. As can be seen in FIG. 1, the base 62 extends over the frame body 88 and the side wall 32 of the ferrule body 24 between the rear end 92 of the frame body 88 and the rear end 30 of the ferrule body 24. Optionally, the engagement segment 68 of the base 62 is engaged with the side wall 32 of the ferrule body 24. The frame body 88 and the ferrule body 24 are held together between the frame arms 76 and the ferrule arms 70 of the connection member 42. Specifically, the engagement segments 74 of the ferrule arms 70 are engaged with the rear face 31 of the ferrule body 24 and the engagement segments 80 of the frame arms 76 are engaged with the rear face 95 of the frame body 88 to hold the frame body 88 and the ferrule body 24 therebetween.

To install the connection member 42 on the ferrule 14 and the frame 22 as shown in FIG. 1, the body 56 of the connection member 42 is deflected from the natural resting position shown in FIG. 3 and positioned over the ferrule 14 and frame 22 as shown. Once in such a position, the bias of the body 56 to the natural resting position biases the ferrule arms 70 into engagement with the ferrule body 24 and biases the frame arms 76 into engagement with the frame body 88. The bias provides a sufficient force to hold the ferrule 14 and the frame 22 together as shown in FIG. 1. Any portions, segments, and/or the like of the connection member body 56 may be deflected to position the body 56, such as, but not limited to, the base 62, the frame arms 76, the ferrule arms 70, and/or the like. To remove the ferrule 14 from the frame 22, the body 56 is deflected such that the ferrule arms 70 and/or the frame arms 76 disengage the ferrule body 24 and/or the frame body 88, respectively. The connection member 42 can the be removed to enable the ferrule body 24 to be removed from the frame receptacle 98.

When the ferrule body 24 is connected to the frame body 88 as shown in FIG. 1, the lens 108 directs optical signals between the ends 48 (FIG. 2) of the optical conductors 46 (FIG. 2) of the optical cable 12 and the active areas 82 (FIG. 4) of the OEDs 20. In the exemplary embodiment, the ferrule body 24 is removably connected to the frame body 88 such that the length of the ferrule body 24 extends approximately parallel to the substrate 18. In some alternative embodiments, the length of the ferrule body 24 extends approximately perpendicular or at an oblique angle relative to the substrate 18. In such alternative embodiments wherein the length of the ferrule body 24 extends approximately perpendicular or at an oblique angle relative to the substrate 18, an emission and/or reception axis (not shown) of the optical conductors 46 may be aligned with the active areas 82 of the OEDs 20 for directing optical signals between the conductors 46 and the OEDs 20 in addition or alternatively to using the lens 108 and/or a reflector.

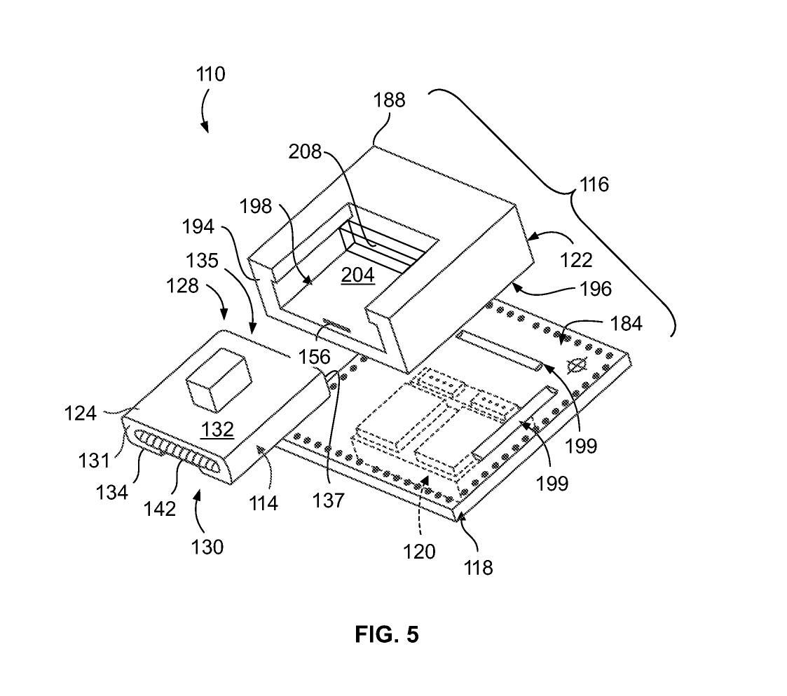

In the exemplary embodiment, the connection member 42 is a separate component from the body 24 of the ferrule 14. However, the connection member 42 is not limited to being a separate component from the ferrule body 24, but rather may form part of the ferrule body 24. For example, FIG. 5 is an exploded perspective view of a portion of an exemplary alternative embodiment of an optical assembly 110. The optical assembly 110 includes an optical cable (not shown, e.g., the optical cable 12 shown in FIGS. 1 and 2), a ferrule 114 configured to terminate the optical cable, and an OED assembly 116. The OED assembly 116 includes a substrate 118, one or more OEDs 120 mounted on the substrate 118, and a frame 122 mounted on a side 184 of the substrate 118. A combination of the optical cable and the ferrule 114 may be referred to herein as an “optical cable assembly”. Additionally, a combination of the optical cable, the ferrule 114, and the frame 122 may be referred to herein as an “optical cable assembly”.

The ferrule 114 is configured to be engaged with and removably connected to the frame 122 of the OED assembly 116 to optically connect the optical cable to the OEDs 120. A body 124 of the ferrule 114 engages a body 188 of the frame 122 with a snap-fit connection to removably connect the ferrule body 124 to the frame body 188. Specifically, the ferrule body 124 extends a length from a front end 128 to a rear end 130, and includes opposite side walls 132 and 134. The side wall 134 includes a latch opening 142, which in the exemplary embodiment extends into the side wall 134 of the ferrule body 124 at the rear end 130. Optionally, the latch opening 142 extends through a rear face 131 of the ferrule body 124. In the exemplary embodiment, the ferrule 114 includes a lens 135. Specifically, the ferrule body 124 includes a front wall 137 that forms a lens 135 through which optical signals are transmitted. The lens 135 of the ferrule 114 directs optical signals between an optional lens 208 of the frame 122 and optical conductors (not shown) of the optical cable.

The body 188 of the frame 122 includes a receptacle 198, which in the exemplary embodiment extends through a front face 194 of the frame body 188. The receptacle 198 is partially defined by a bottom wall 204. The frame body 188 includes a latch embossment 156 that extends outwardly on the bottom wall 204. The latch opening 142 of the ferrule 114 is configured to receive the latch embossment 156 of the frame 122 therein with a snap-fit arrangement to removably connect the ferrule 114 to the frame 122. More particularly, portions of the ferrule body 124 that are proximate or define the latch opening 142 may be deflected, elastically deformed, and/or the like by engagement with the latch embossment 156 to enable the latch embossment 156 to “snap” into the latch opening 142. In addition or alternatively, the latch embossment 156 may be deflected, elastically deformed, and/or the like by engagement with the ferrule body 124 to enable the latch embossment 156 to “snap” into the latch opening 142. The ferrule 114 can be removed from the receptacle 198 of the frame 122 by providing sufficient force to the ferrule body 124 and/or the frame body 188 to deflect, elastically deform, and/or the like the ferrule body 124 and/or the latch embossment 156 to enable the latch embossment 156 to be removed from the latch opening 142. In some alternative embodiments, the ferrule body 124 includes the latch embossment 156 and the frame body 188 includes the latch opening 142.

Optionally, the substrate 118 includes one or more grooves 199 on the side 184 of the substrate 118 that receive protrusions (not shown) that extend outwardly on a bottom side 196 of the frame body 188. The grooves 199 and the protrusions facilitate aligning the frame 122 on the substrate 118. The grooves 199 and the protrusions may also connect together in a manner (e.g, via friction, stiction, a snap-fit connection, and/or the like) that facilitates holding the frame 122 on the substrate 118.

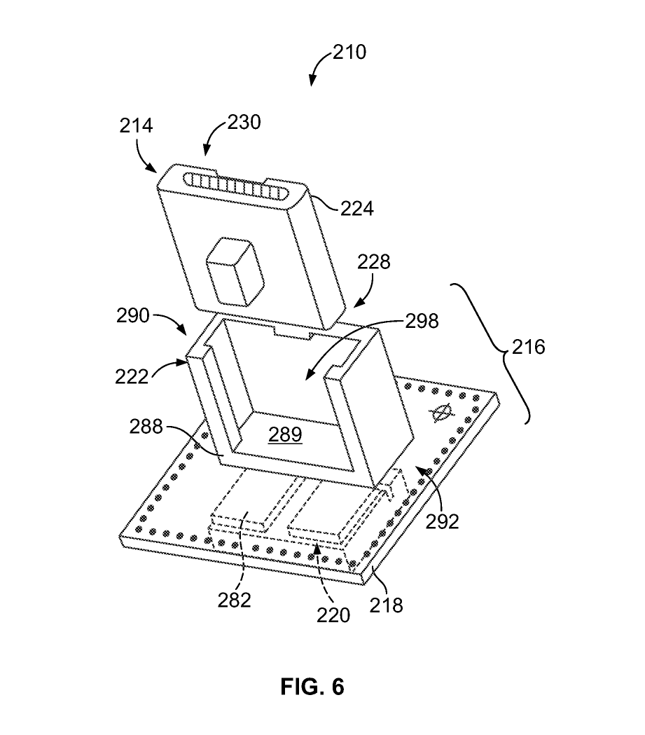

FIG. 6 is an exploded perspective view of a portion of another exemplary alternative embodiment of an optical assembly 210. The optical assembly 210 includes an optical cable (not shown, e.g., the optical cable 12 shown in FIGS. 1 and 2), a ferrule 214 configured to terminate the optical cable, and an OED assembly 216. The OED assembly 216 includes a substrate 218, one or more OEDs 220 mounted on the substrate 218, and a frame 222 mounted on the substrate 218. The ferrule 214 is configured to be engaged with and removably connected to the frame 222 in a snap-fit connection that is substantially similar to the snap-fit connection between the ferrule 114 (FIG. 5) and the frame 122 (FIG. 5) of the optical assembly 110 (FIG. 5). A combination of the optical cable and the ferrule 214 may be referred to herein as an “optical cable assembly”. Additionally, a combination of the optical cable, the ferrule 214, and the frame 222 may be referred to herein as an “optical cable assembly”.

The ferrule 214 includes a body 224 that extends a length from a front end 228 to a rear end 230. As described above with respect to the optical assembly 10 (FIG. 1), the length of the body 224 of the ferrule 214 need not extend approximately parallel to the substrate 218 when removably connected to the frame 222. Rather, the length of the ferrule body 224 may extend approximately perpendicular or at an oblique angle relative to the substrate 218 when the ferrule body 224 is removably connected to the frame 222. In the exemplary embodiment of FIG. 6, the length of the ferrule body 224 extends approximately perpendicular relative to the substrate 218. More specifically, the frame 222 includes a body 288 that extends a length from a front end 290 to a rear end 292. The frame body 288 is mounted on the substrate along the rear end 292 such that the length of the frame body 288 extends approximately perpendicular to the substrate 218. A receptacle 298 of the frame body 288 that receives the ferrule body 224 therein is oriented relative to the substrate 218 such that the length of the ferrule body 224 extends approximately perpendicular to the substrate 218 when the ferrule body 224 is received within the receptacle 298 of the frame body 288. In the exemplary embodiment of FIG. 6, the ferrule 214 aligns the end (not shown) of one or more optical conductors (not shown) of the optical cable with one or more active areas 282 of the OEDs 220. For example, an emission and/or reception axis (not shown) of the optical conductors may be aligned with the active areas 282 of the OEDs 220 for directing optical signals between the conductors and the OEDs 220. A wall 289 of the frame body 288 is at least partially transparent such that optical signals can be transmitted through the wall 289 between the optical conductors and the OEDs 220.

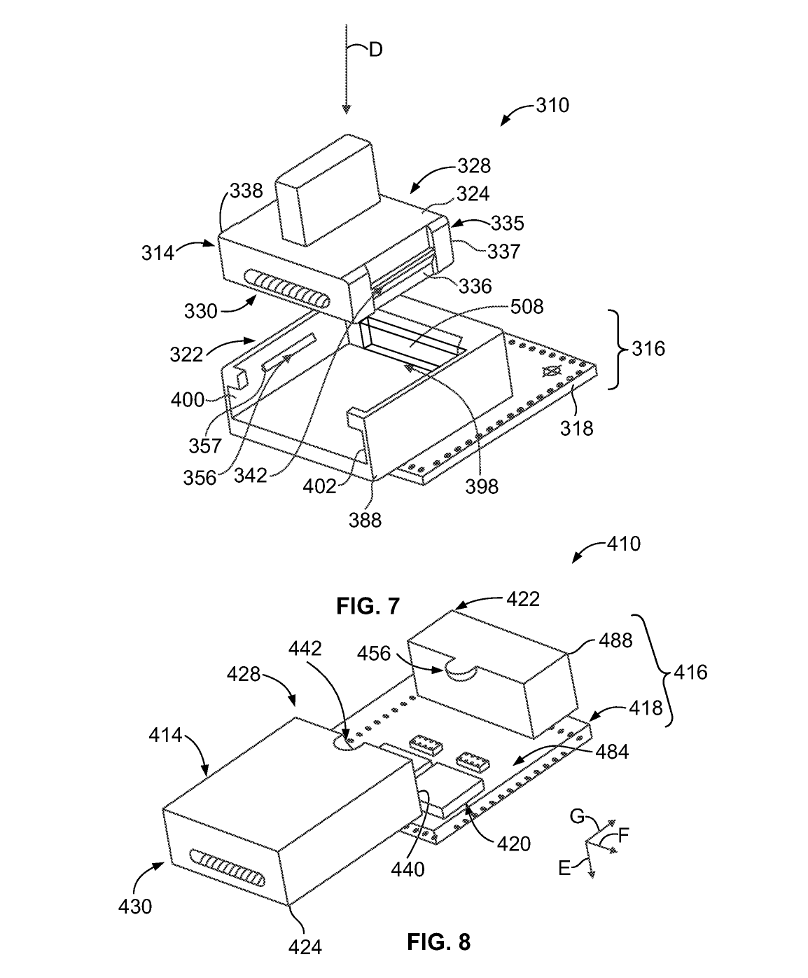

FIG. 7 is a partially exploded perspective view of a portion of another exemplary alternative embodiment of an optical assembly 310. The optical assembly 310 includes an optical cable (not shown, e.g., the optical cable 12 shown in FIGS. 1 and 2), a ferrule 314 configured to terminate the optical cable, and an OED assembly 316. The OED assembly 316 includes a substrate 318 and one or more OEDs (not shown) mounted on the substrate 318. The OED assembly 316 also includes a frame 322 mounted on the substrate 318. A combination of the optical cable and the ferrule 314 may be referred to herein as an “optical cable assembly”, while a combination of the optical cable, the ferrule 314, and the frame 322 may also be referred to herein as an “optical cable assembly”.

To optically connect the optical cable to the OEDs, the ferrule 314 is configured to be engaged with and removably connected to the frame 322. The ferrule 314 includes a body 324 that engages a body 388 of the frame 322 with a snap-fit connection to removably connect the ferrule body 324 to the frame body 388. Particularly, the ferrule body 324 extends a length from a front end 328 to a rear end 330, and includes opposite side walls 336 and 338. The side walls 336 and 338 include latch projections 342 that extend outwardly. The frame body 388 includes a receptacle 398, which in the exemplary embodiment is partially defined by opposing side walls 400 and 402 of the body 388. The body 388 of the frame 322 includes latch extensions 356 that extend outwardly on the side walls 400 and 402 and inwardly into the receptacle 398. Each latch extension 356 includes a latch shoulder 357. To removably connect the ferrule body 324 to the frame body 388, the ferrule body 324 is inserted into the receptacle 398 in the direction of the arrow D. The latch projections 342 of the ferrule 314 are configured to engage the latch shoulders 357 of the latch extensions 356 of the frame 322 with a snap-fit connection to removably connect the ferrule body 324 to the frame body 388.

In the exemplary embodiment, the ferrule 314 includes a lens 335. Specifically, the ferrule body 324 includes a front wall 337 that forms a lens 335 through which optical signals are transmitted. The lens 335 of the ferrule 314 directs optical signals between an optional lens and/or reflector 508 of the frame 322 and optical conductors (not shown) of the optical cable.

FIG. 8 is a partially exploded perspective view of a portion of yet another exemplary alternative embodiment of an optical assembly 410. The embodiment shown in FIG. 8 illustrates another example of a snap-fit connection between a ferrule 414 and a frame 422. The optical assembly 410 includes an optical cable (not shown, e.g., the optical cable 12 shown in FIGS. 1 and 2), the ferrule 414, and an OED assembly 416. The ferrule 414 is configured to terminate the optical cable. The OED assembly 416 includes a substrate 418, one or more OEDs 420 mounted on the substrate 418, and a frame 422 mounted on a side 484 of the substrate 418. As can be seen in FIG. 8, the OEDs 420 are mounted on the side 484 of the substrate 418 for emitting and/or receiving optical signals on the side 484 in an arrangement wherein the optical signals are not transmitted through a thickness of the substrate 418. A combination of the optical cable and the ferrule 414 may be referred to herein as an “optical cable assembly”. A combination of the optical cable, the ferrule 414, and the frame 422 may also be referred to herein as an “optical cable assembly”.

The ferrule 414 is configured to be engaged with and removably connected to the frame 422 of the OED assembly 416 to optically connect the optical cable to the OEDs 420. More particularly, a body 424 of the ferrule 414 engages a body 488 of the frame 422 with a snap-fit connection to removably connect the ferrule body 424 to the frame body 488. The ferrule body 424 extends a length from a rear end 430 to a front end 428, which includes a front face 440. The ferrule body 424 includes a latch opening 442, which in the exemplary embodiment is located at the front end 428 of the body 424. Optionally, the latch opening 442 extends through the front face 440 of the ferrule body 424. The body 488 of the frame 422 includes a ball snap 456. The latch opening 442 of the ferrule 414 is configured to receive the ball snap 456 of the frame 422 therein with a snap-fit connection to removably connect the ferrule 414 to the frame 422. More particularly, the ball snap 456 is deflected by engagement with the ferrule body 424 to enable the ball snap 456 to “snap” into the latch opening 442. The snap-fit connection between the ball snap 456 and the latch opening 442 may facilitate aligning the ferrule 414 with the OEDs 420 and/or the frame 422. For example, the snap-fit connection may facilitate aligning the ends 48 (FIG. 2) of the optical conductors 46 (FIG. 2) held by the ferrule 414, a lens (not shown) of the ferrule 414, and/or a reflector (not shown) of the ferrule 414 with the OEDs 420. Moreover, and for example, the snap-fit connection may facilitate aligning the ends 48 (FIG. 2) of the optical conductors 46 (FIG. 2) held by the ferrule 414, a lens (not shown) of the ferrule 414, and/or a reflector (not shown) of the ferrule 414 with a lens (not shown) and/or a reflector (not shown) of the frame 422. To align the ferrule 414 with the OEDs 420 and/or the frame 422, the snap-fit connection exerts alignment forces that act on the ferrule 414 in the directions of the arrows E, F, and G of FIG. 8, for example to position the ferrule 414 relative to one or more datums on the substrate 418 and/or the frame 422. In some alternative embodiments, the ferrule body 424 includes the ball snap 456 and the frame body 488 includes the latch opening 442.

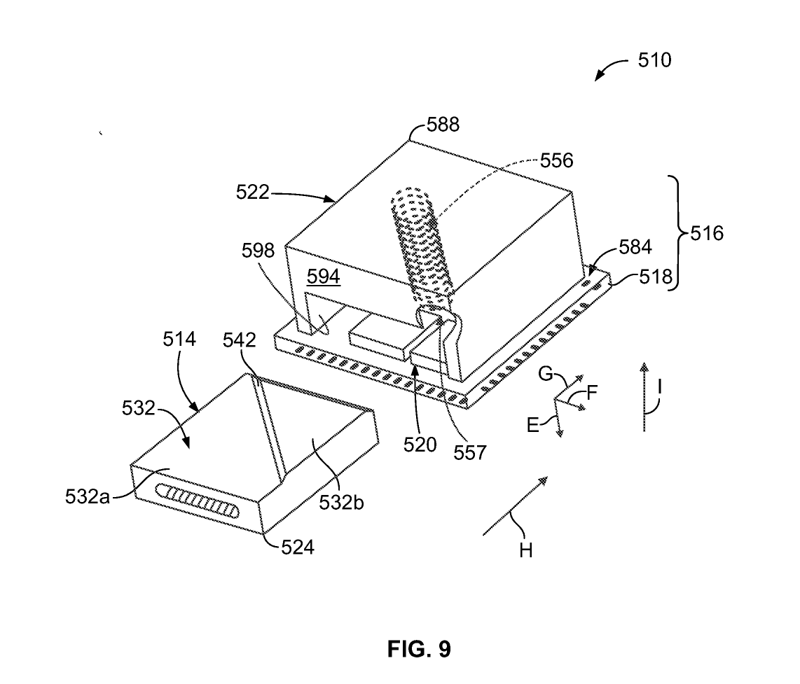

FIG. 9 is a partially exploded perspective view of a portion of still another exemplary alternative embodiment of an optical assembly 510. The embodiment shown in FIG. 9 illustrates an example wherein a ferrule 514 is removably connected to a frame 522 using a spring 556. The optical assembly 510 includes an OED assembly 516, the ferrule 514, and an optical cable (not shown, e.g., the optical cable 12 shown in FIGS. 1 and 2). The ferrule 514 is configured to terminate the optical cable. The OED assembly 516 includes a substrate 518, one or more OEDs 520 mounted on a side 584 of the substrate 518, and a frame 522 mounted on the substrate 518. A combination of the optical cable and the ferrule 514 may be referred to herein as an “optical cable assembly”. A combination of the optical cable, the ferrule 514, and the frame 522 may also be referred to herein as an “optical cable assembly”.

The ferrule 514 is configured to be engaged with and removably connected to the frame 522 using the spring 556 to optically connect the optical cable to the OEDs 520. A body 524 of the ferrule 514 includes a side wall 532 having a ridge 542. In the exemplary embodiment, the ridge 542 divides the side wall 532 into two segments 532a and 532b, wherein the segment 532b is raised from the segment 532a. The spring 556 is held by a body 588 of the frame 522. In the exemplary embodiment, frame body 588 includes an opening 557 within which the spring 556 extends. Optionally, the opening 557 extends through a front face 594 of the frame body 588. The body 588 of the frame 522 includes a receptacle 598 that receives the ferrule body 524 therein. At least a portion of the spring 556 extends within the receptacle 598. To removably connect the ferrule 514 to the frame 522, the ferrule body 524 is inserted into the receptacle 598 in the direction of the arrow H. The raised segment 532b of the side wall 532 of the ferrule body 524 engages the spring 556 and deflects the spring 556 (such as, but not limited to, in the direction of the arrow I and/or the like). As the raised segment 532b clears the spring 556, the bias of the spring 556 urges the spring 556 into engagement with the ridge 542 to removably connect the ferrule body 524 to the frame body 588. In some alternative embodiments, the spring 556 is held by the ferrule body 524 and the frame body 588 includes the ridge 542.

The spring 556 may facilitate aligning the ferrule 514 with the OEDs 520 and/or the frame 522. For example, the spring 556 may facilitate aligning the ends 48 (FIG. 2) of the optical conductors 46 (FIG. 2) held by the ferrule 514, a lens (not shown) of the ferrule 514, and/or a reflector (not shown) of the ferrule 514 with the OEDs 520. Moreover, and for example, the spring 556 may facilitate aligning the ends 48 (FIG. 2) of the optical conductors 46 (FIG. 2) held by the ferrule 514, a lens (not shown) of the ferrule 514, and/or a reflector (not shown) of the ferrule 514 with a lens (not shown) and/or a reflector (not shown) of the frame 522. The spring 556 may exert alignment forces that act on the ridge 542 of the ferrule body 524 in the directions of the arrows E, F, and G of FIG. 9, for example to position the ferrule 514 relative to one or more datums on the substrate 518 and/or the frame 522.

As can be seen in FIG. 9, the OEDs 520 are mounted on the side 584 of the substrate 518 for emitting and/or receiving optical signals on the side 584 in an arrangement wherein the optical signals are not transmitted through a thickness of the substrate 518. The ferrule 514 includes a lens (not shown), a reflector (not shown), and/or one or more openings (not shown) within the body 524 for directing optical signals between optical conductors (not shown) of the optical cable and the OEDs 520.

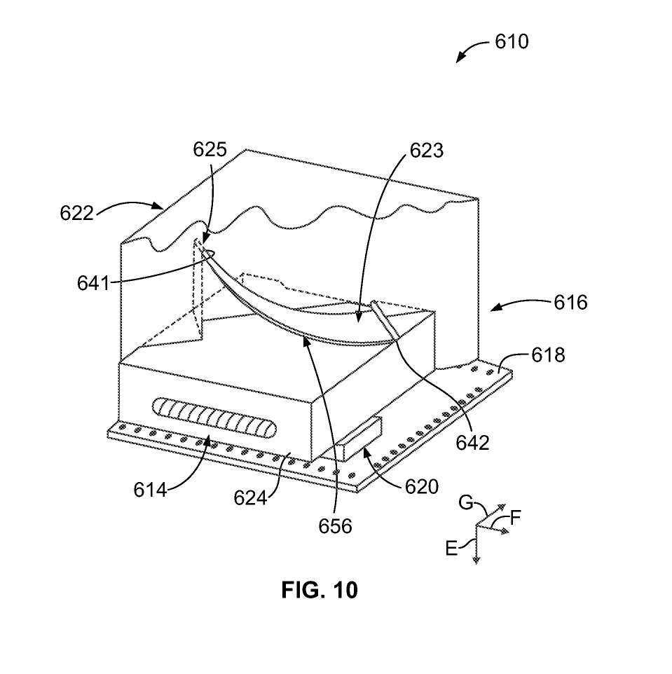

In the exemplary embodiment of FIG. 9, the spring 556 is a coil spring. However, the spring 556 may additionally or alternatively include any other type of spring. For example, FIG. 10 is a broken-away perspective view of a portion of another exemplary alternative embodiment of an optical assembly 610 wherein a leaf spring 656 (sometimes referred to as a “snap spring”) is used to removably connect a ferrule 614 to a frame 622. The optical assembly 610 includes an OED assembly 616, the ferrule 614, and an optical cable (not shown, e.g., the optical cable 12 shown in FIGS. 1 and 2) configured to be terminated by the ferrule 614. The OED assembly 616 includes a substrate 618, one or more OEDs 620, and the frame 622. A body 624 of the ferrule 614 includes a ridge 642. An end 623 of the spring 656 is engaged with the ridge 642. An end 625 of the spring 656 that is opposite the end 623 is engaged with a ridge 641 of the frame 622 to removably connect the ferrule 614 to the frame 622. A combination of the optical cable and the ferrule 614 may be referred to herein as an “optical cable assembly”, while a combination of the optical cable, the ferrule 614, and the frame 622 may also be referred to herein as an “optical cable assembly”.

The spring 656 may facilitate aligning the ferrule 614 with the OEDs 620 and/or the frame 622. For example, the spring 656 may facilitate aligning the ends 48 (FIG. 2) of the optical conductors 46 (FIG. 2) held by the ferrule 614, a lens (not shown) of the ferrule 514, and/or a reflector (not shown) of the ferrule 614 with the OEDs 620. Moreover, and for example, the spring 656 may facilitate aligning the ends 48 (FIG. 2) of the optical conductors 46 (FIG. 2) held by the ferrule 614, a lens (not shown) of the ferrule 614, and/or a reflector (not shown) of the ferrule 614 with a lens (not shown) and/or a reflector (not shown) of the frame 622. To align the ferrule 614 with the OEDs 620 and/or the frame 622, the spring 656 exerts alignment forces that act on the ridge 642 of the ferrule body 624 in the directions of the arrows E, F, and G, for example to position the ferrule 614 relative to one or more datums on the substrate 618 and/or the frame 622.

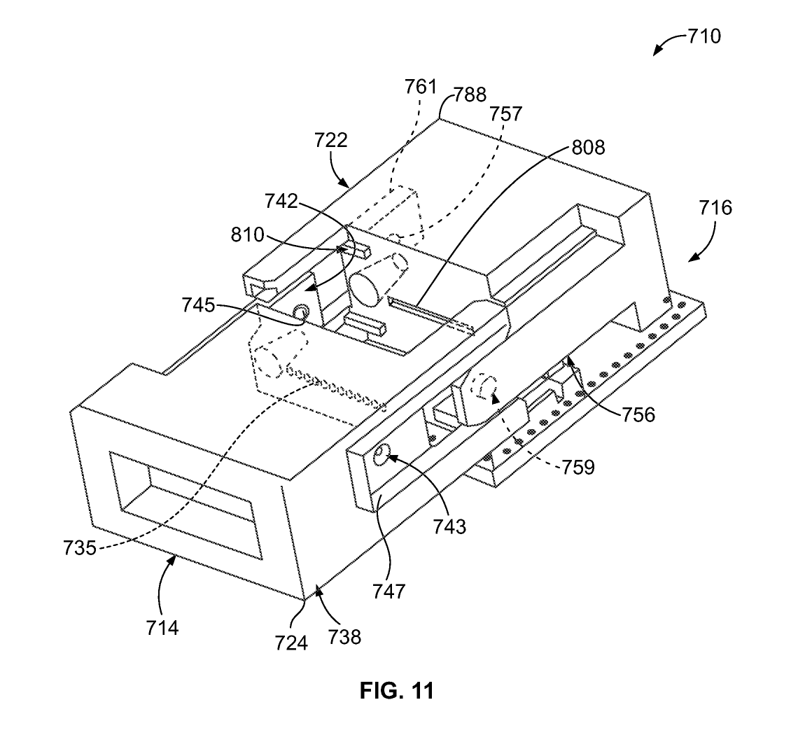

FIG. 11 is a partially exploded perspective view of a portion of yet another exemplary alternative embodiment of an optical assembly 710. A ferrule 714 is configured to terminate an optical cable (not shown, e.g., the optical cable 12 shown in FIGS. 1 and 2). The ferrule 714 is configured to be engaged with and removably connected to the frame 722 of an OED assembly 716 to optically connect the optical cable to one or more OEDs 720 of the OED assembly 716. A combination of an optical cable and the ferrule 714 may be referred to herein as an “optical cable assembly”. A combination of an optical cable, the ferrule 714, and the frame 722 may be referred to herein as an “optical cable assembly”.

A body 724 of the ferrule 714 engages a body 788 of the frame 722 with a snap-fit connection to removably connect the ferrule body 724 to the frame body 788. The body 724 of the ferrule 714 includes a latch arm 742 and a latch recess 743 on opposite sides 736 and 738 of the body 724. The latch arm 742 includes a detent 745. The frame body 788 also includes a latch recess 757 and latch arm 756, which includes a detent 759. The latch arm 756 of the frame body 788 is positioned to cooperate with the latch recess 743 of the ferrule body 724, while the latch arm 742 of the ferrule body 724 is configured to cooperate with the latch recess 757 of the frame body 788. Specifically, the detent 759 of the latch arm 756 of the frame 722 engages the latch recess 743 of the ferrule 714 with a snap-fit connection. Similarly, the detent 745 of the latch arm 742 of the ferrule 714 engages the latch recess 757 of the frame 722 with a snap-fit connection.

Optionally, the ferrule body 724 and/or the frame body 788 include a slot 747 and 761, respectively, that receives the respective latch arm 756 and 742 therein. In some alternative embodiments, the latch recess 743 extends into the latch arm 756 of the frame body 788 and the ferrule body 724 includes the detent 759. Similarly, in some alternative embodiments, the latch recess 757 extends into the latch arm 742 of the ferrule body 724 and the frame body 788 includes the detent 745.

The ferrule 714 and/or the frame 722 optionally includes a lens 735 and 808, respectively. In embodiments wherein both the ferrule 714 and the frame 722 include the lens 735 and 808, respectively, the ferrule body 724 and/or the frame body 788 may include a standoff 810 to prevent the lenses 735 and 808 from touching when the ferrule body 724 is connected to the frame body 788.

Referring again to FIG. 2, although two are shown, the optical cable 12 may include any number of the optical conductors 46. In some alternative embodiments, the optical cable 12 includes only a single optical conductor 46. Optionally, one or more of the optical conductors 46 of the optical cable 12 may be optically insulated, optically shielded, and/or the like from one or more other optical conductors 46 of the cable 12. Each optical conductor 46 may be fabricated from any materials that enable the optical conductor 46 to transmit optical signals, such as, but not limited to, a fiber optic material and/or the like. Each optical conductor 46 may include any number of strands, fibers, and/or the like of material.

Referring again to FIG. 4, the OEDs 20 may each be any device that is configured to convert optical signals into electrical signals and/or is configured to convert electrical signals into optical signals. For example, each OED 20 may be, but is not limited to being, a laser (e.g., vertical cavity surface emitting laser (VCSEL), double channel, planar buried heterostructure (DC-PBH), buried crescent (BC), distributed feedback (DFB), distributed Bragg reflector (DBR), and/or the like), light emitting diodes (LEDs) (e.g., surface emitting LED (SLED), edge emitting LED (ELED), super luminescent diode (SLD), and/or the like), photodiodes (e.g., P Intrinsic N (PIN), avalanche photodiode (APD), and/or the like), and/or the like. The OED assembly 16 may include any number of the OEDs 20, whether or not the number of OEDs 20 is the same as the number of optical conductors 46 of the optical cable 12.

The substrate 18 may be a flexible substrate or a rigid substrate. The substrate 18 may be fabricated from and/or may each include any material(s), such as, but not limited to, ceramic, epoxy-glass, polyimide (such as, but not limited to, Kapton® and/or the like), organic material, glass (such as, but not limited to, Pyrex® and/or the like), plastic, polymer, and/or the like. In some embodiments, the substrate 18 is a rigid substrate fabricated from epoxy-glass, such that the substrate 18 is what is sometimes referred to as a “circuit board” or a “printed circuit board”. As used herein, the term “printed circuit” is intended to mean any electric circuit in which the conducting connections have been printed or otherwise deposited in predetermined patterns on and/or within an electrically insulating substrate. In addition or alternative to the shape shown and/or described herein, the receptacle 98 of the frame 22 may include any other shapes for receiving a ferrule 14 including any shapes.

The embodiments described and/or illustrated herein may provide apparatus for removably connecting an optical cable to one or more OEDs that is less bulky than at least some known apparatus that connect an optical cable to one or more OEDs.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the subject matter described and/or illustrated herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

1. An optical cable assembly for being connected to an opto-electric device assembly having a substrate, an opto-electric device (OED) mounted on the substrate, and a frame mounted on the substrate, the optical cable assembly comprising:
an optical cable comprising an optical conductor having an end; and
a ferrule terminating the optical cable, the ferrule comprising a body having a chamber, the optical conductor being held by the ferrule such that at least a portion of the end of the optical conductor extends within the chamber of the body of the ferrule, wherein the body of the ferrule is configured to be engaged with and removably connected to the frame of the opto-electric device assembly to optically connect the optical conductor to the OED, wherein at least one of the frame or the ferrule comprises at least one of a reflector or a lens that is a discrete from the optical conductor, the at least one of the reflector or lens being configured to be optically coupled between the end of the optical conductor and the OED for directing optical signals between the end of the optical conductor and the OED.

2. The optical cable assembly of claim 1, wherein the ferrule comprises a connection member, the body of the ferrule being configured to be removably connected to the frame via engagement of the connection member with the frame, the connection member comprising a spring clip having a ferrule arm and a frame arm, the ferrule arm being configured to be engaged with the body of the ferrule and the frame arm being configured to be engaged with the frame.

3. The optical cable assembly of claim 1, wherein the ferrule comprises a connection member, the body of the ferrule being configured to be removably connected to the frame via engagement of the connection member with the frame, the connection member comprising a spring clip having a base, a ferrule arm that extends from the base, and a frame arm that extends from the base, the base being configured to extend over the frame and the body of the ferrule between an end of the frame and an end of the body of the ferrule, wherein the frame arm is configured to be engaged with the end of the frame and the ferrule arm is configured to be engaged with the end of the body of the ferrule to hold the frame and the body of the ferrule together between the ferrule and frame arms.

4. The optical cable assembly of claim 1, wherein the body of the ferrule is configured to engage the frame with a snap-fit connection to removably connect the body of the ferrule to the frame.

5. The optical cable assembly of claim 1, wherein the frame includes a latch embossment, the body of the ferrule comprising a latch opening that is configured to receive the latch embossment therein to removably connect the body of the ferrule to the frame.

6. The optical cable assembly of claim 1, wherein the body of the ferrule comprises a latch projection, the frame including a latch shoulder, the latch projection of the body of the ferrule being configured to engage the latch shoulder of the frame with a snap-fit connection to removably connect the body of the ferrule to the frame.

7. The optical cable assembly of claim 1, wherein the frame includes a ball snap, the body of the ferrule comprising a latch opening that is configured to receive the ball snap therein with a snap-fit connection to removably connect the body of the ferrule to the frame.

8. The optical cable assembly of claim 1, further comprising a spring, wherein the body of the ferrule comprises a ridge, the spring being configured to be engaged between the frame and the ridge of the body of the ferrule to removably connect the body of the ferrule to the frame.

9. (canceled)

10. (canceled)

11. An optical assembly comprising:
an opto-electric device assembly having a substrate, an opto-electric device (OED) mounted on the substrate, and a frame mounted on the substrate, the OED being configured to at least one of convert optical signals to electrical signals or convert electrical signals to optical signals;
an optical cable comprising an optical conductor having an end; and
a ferrule terminating the optical cable, the ferrule comprising a body having a chamber, the optical conductor being held by the ferrule such that at least a portion of the end of the optical conductor extends within the chamber of the body of the ferrule, wherein the body of the ferrule is engaged with and removably connected to the frame of the opto-electric device assembly to optically connect the optical conductor to the OED.

12. The optical assembly of claim 11, wherein the ferrule comprises a connection member, the body of the ferrule being removably connected to the frame via engagement of the connection member with the frame, the connection member comprising a spring clip having a ferrule arm and a frame arm, the ferrule arm being engaged with the body of the ferrule and the frame arm being engaged with the frame.

13. The optical assembly of claim 11, wherein the frame comprises a latch embossment, the body of the ferrule comprising a latch opening, the body of the ferrule being removably connected to the frame via reception of the latch embossment within the latch opening.

14. The optical assembly of claim 11, wherein the body of the ferrule comprises a latch projection and the frame comprises a latch shoulder, the latch projection of the body of the ferrule engaging the latch shoulder of the frame with a snap-fit connection to removably connect the body of the ferrule to the frame.

15. (canceled)

16. (canceled)

17. The optical assembly of claim 11, wherein at least one of the ferrule or the frame directs light emitted from the end of the optical conductor to the OED.

18. The optical assembly of claim 11, wherein the optical conductor is held by the ferrule such that the end of the optical conductor is aligned with the OED.

19. The optical assembly of claim 11, wherein the body of the ferrule is removably connected to the frame such that the length of the body of the ferrule extends approximately perpendicular to the substrate of the electro-optical device assembly.

20. An optical cable assembly for being connected to an opto-electric device assembly having an opto-electric device (OED) and a substrate, the assembly comprising:
an optical cable comprising an optical conductor having an end;
a frame configured to be mounted on the substrate of the opto-electric device assembly; and
a ferrule terminating the optical cable, the ferrule comprising a body having a chamber, the optical conductor being held by the ferrule such that at least a portion of the end of the optical conductor extends within the chamber of the body of the ferrule, wherein the body of the ferrule is engaged with and removably connected to the frame to optically connect the optical conductor to the OED.

21. The optical cable assembly of claim 20, wherein at least one of the frame or the ferrule comprises at least one of a reflector or a lens that is a discrete from the optical conductor, the at least one of the reflector or lens being configured to be optically coupled between the end of the optical conductor and the OED for directing optical signals between the end of the optical conductor and the OED.

22. The optical cable assembly of claim 20, wherein the ferrule comprises a spring clip that extends a length from a first free end to a second free end that is opposite the first free end, the spring clip comprising a ferrule arm that defines the first free end of the spring clip and comprising a frame arm that defines the second free end of the spring clip, the ferrule and frame arms being configured to be engaged with the body of the ferrule and the frame, respectively, to hold the frame and the body of the ferrule together between the ferrule and frame arms.

23. The optical assembly of claim 11, wherein at least one of the frame or the ferrule comprises at least one of a reflector or a lens that is a discrete from the optical conductor, the at least one of the reflector or lens being configured to be optically coupled between the end of the optical conductor and the OED for directing optical signals between the end of the optical conductor and the OED.

24. The optical cable assembly of claim 1, wherein the ferrule comprises a spring clip that extends a length from a first free end to a second free end that is opposite the first free end, the spring clip comprising a ferrule arm that defines the first free end of the spring clip and comprising a frame arm that defines the second free end of the spring clip, the ferrule and frame arms being configured to be engaged with the body of the ferrule and the frame, respectively, to hold the frame and the body of the ferrule together between the ferrule and frame arms.
